(19) United States
(12) Patent Application Publication
(10) Pub. No.: US 2009/0010466 A1
(43) Pub. Date: Jan. 8, 2009

(54) Hearing Agent and a Related Method

(76) Inventor: Pentti O. A. Haikonen, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/223,516

(22) PCT Filed: Feb. 3, 2006
(86) PCT No.: PCT/FI2006/000031

§ 371 Date: Jul. 31, 2008

(51) Int. Cl. H04R 25/00

(52) U.S. Cl. 381/315

(57) ABSTRACT

A hearing agent being an entity capable of recognizing a number of predetermined sounds by an associative matrix and providing the user of the entity with an alert indicating the particular recognized sound, and a corresponding method. The agent may be implemented as a dedicated device, a module attachable to another device, or software introduced to a more general device such as a mobile terminal or a PDA.

### FIELD OF THE INVENTION

The present invention relates generally to electronic appliances. In particular the invention concerns provision of technical assistance to people with impaired hearing.

### BACKGROUND OF THE INVENTION

The overall number of hearing-impaired people around the world was 250 million according to the recent estimate by the WHO in 2005. The figure corresponds to several percents of the earth's total population, and actually only those who really suffer from their disability are included in the amount. Exemplary scenarios wherein a hearing defect causes negative consequences with a high likelihood may take place at home, work, outdoors, while travelling; basically everywhere. For example, water may be boiling over at the kitchen and keeping hiss just not loud enough, an activated door bell or a phone ring tone is not heard, fire alarm is not perceived, traffic noises caused by oncoming vehicles thus indicating a potential danger are omitted, etc. Therefore, a hearing defect, either a complete deafness or a less serious handicap, incontrovertibly complicates performing different free-time and work related activities, and therefore also degrades the general way of life; that's why the problem has been addressed since the infancy of the civilization with numerous different hearing aids starting from a stethoscope-type purely mechanical solutions conveying the sound to the target person's ear canal and ending up in sophisticated electronic hearing aids reminding of an earpiece in form.

Further, traditionally also hearing dogs, such like the guide dogs for the blind, have been used to provide hearing-impaired people with indispensable aid for performing various everyday tasks and more specific functions. A hearing dog is trained to recognize and act upon sounds that the owner would prefer to hear. The dog then alerts the owner by tactile maneuver, e.g. a muzzle push, and guides the owner to the sound source, for example. At home such sounds include aforesaid telephone and mobile terminal ring tones, fire alarm, doorbell, alarm clock, etc.

However, utilization of different tailored appliances or a hearing dog is not always enjoyable or even possible. Some people consider odd to continuously wear specific earpieces for improving the perceived aural sensations. Moreover, the negative psychological effect arising from explicitly marking oneself as disabled cannot be completely set aside either. These factors render the hearing aids somewhat useless from the standpoint of potential users who however do not necessarily need them to cope with daily duties. Yet, there are only a limited number of hearing dogs available, which funnels their use to the population group that most desperately needs them, i.e. the people with serious hearing defect. Some persons otherwise willing and capable of maintaining a dog are simply allergic to those. Admittedly, although a hearing dog will enhance the way of life in many occasions, it may also affect reversely in a number of environments, considering e.g. restaurants and public transport. Even if the hearing dog is properly trained, which is a demanding process in itself, the gestures it makes to the host for describing the perceived sound always contain some level of randomness due to which a possibility of interpretation error exists between the dog and the host; indeed, both the entities are different living creatures with their own will and state of mind affecting the respective behaviour thereof.

An exemplary block diagram of a prior art electronic hearing aid is disclosed in FIG. 1. The hearing aid is nowadays typically installed (close) to the target person's ear, although also hearing organ (cochlear) or middle ear/bone-anchored implants are available for people with more severe hearing loss. The hearing aid depicted by sketch 102 is a so-called behind-the-ear hearing aid that, as the name says, fits behind the target person's ear and contains a specific projection 104 called an earmold that can be inserted to the outer auditory canal. It is especially modeled so as to direct and focus the sound waves to the ear. From the functional standpoint the hearing aid comprises a microphone 106 to capture incoming sound signals, an amplifier 108 to amplify the captured sounds, and a loudspeaker 110 to forward the amplified signal deeper into the ear. The hearing aid is powered by a battery 112. An ear hook 116 connects the casing 114, wherein most of the required electronics are located, and the earmold 104.

Publication WO96/36301 discloses a portable alarm system for people with impaired hearing. The system includes a portable sound recognition unit that picks up surrounding acoustical signals and, based on a back-propagation type neural network algorithm, identifies a number of predetermined (˜taught) sounds such as a doorbell, fire alarm, or a telephone signal therefrom. The recognition unit then sends a respective digital signal to a wristworn receiver unit that informs the host of the identified sound by a visual and vibrotactile characteristic signal.

Publication WO02/29743 discloses a wireless communications device that detects various predetermined sounds and correspondingly alerts the device user by vibration and a text message on the display. A message may also be transmitted to another device. A predetermined set of sounds is stored in the device utilizing the PCM format, and the input sounds are then converted into the same format prior comparing them with the stored ones for recognition.

Notwithstanding the various classic hearing aid arrangements for intensifying the natural hearing experience or otherwise offering corresponding information to the target person, e.g. through the use of hearing dogs, situations still occur, as also being listed hereinbefore, whereto none of the prior art solutions seems to fit particularly well. Even the more modern solutions as previewed by the aforesaid publications contain features that do not suit all the possible use scenarios equally nicely; e.g. the training process of the sound recogniser by back-propagation is often time and memory consuming, and further, utilization of at least two separate and dedicated units is not suitable for temporary or transient usage environment in contrast to mere home conditions, where indeed several detection units communicating with the personal receiver may be attached to desired locations without a continuous relocation pressure. Anyhow, all these physically separated units shall still be independently managed, i.e. provided with the operating voltage, proper fastening, settings, etc. Carrying a tailored receiver unit is always a burden of its own. In addition, for example storing PCM format sounds, while admittedly being a simple technical exercise as such, consumes a considerable amount of memory space, and comparison between several time domain PCM sounds is generally rather exhaustive, awkward and eventually fairly unreliable procedure due to the sensitivity of the time domain envelopes of sound signals in general; small variations in sound source position and distance without forgetting the nature of prevalent background noise may thus alter the time domain representations of the received acoustic signals considerably, which implies that the inputted sounds do not seem to match any of the stored versions. Activating the alert is thus either completely omitted or it erroneously represents a sound not present in the received audio signal.

### SUMMARY OF THE INVENTION

The objective of the present invention is to alleviate the defects found in prior art hearing aid arrangements by a hearing aid of a novel type.

According to the basic concept of the invention, the object is achieved with a hearing agent, substantially a portable electronic device that is configured to associate predetermined acoustic signals (˜sounds in colloquial terms) with predetermined responses alerting the target person and also indicating him (or her) the origin and/or the nature of the sounds. The agent has a first operational mode called a “training mode” during which the associations are created by utilizing an associative matrix or a functionally equivalent solution that has been programmed, based on a number of predetermined acoustic signals to be recognized, to associate each predetermined response, via the matrix output, with a predetermined group of auditory feature values that is input to the matrix and originally determined from the corresponding predetermined acoustic signal. The matrix includes a plurality of stored association weight values as cells thereof. The weight values form the associative link between the input auditory feature values and matrix output.

Then, upon monitoring the environment during a second mode called a “recognition mode”, a number of auditory feature values are determined from an acoustic signal sensed from the environment. The auditory feature values indicate presence or non-presence of predetermined auditory features. The auditory feature values are input to matrix that evokes, via the link created by the weight values, an output that is associatively best match with the input auditory feature values. The responses may be auditory, visual, or both. The weight values may be stored as binary arrays, each digit representing the presence or non-presence of a predetermined auditory feature, for example. The agent may be an independent device or an integrated feature/module of an aggregate entity such as a mobile terminal, a PDA (Personal Digital Assistant), or a robot.

In one aspect of the invention a portable hearing agent comprising
an audio sensor for transforming an acoustic signal into a representative electric signal,
a processing unit configured, while in a training mode, to associate the sensed signal with a predetermined response, and, while in a recognition mode, to activate the predetermined response,
output means for alerting a user of the agent and indicating the acoustic signal via the predetermined response,
   is characterized in that it further comprises
an auditory feature extractor for determining auditory feature values of the sensed signal, said auditory feature values indicating presence or non-presence of predetermined auditory features,
an associative matrix adapted to store, while in said training mode, weight values representing an association between said auditory feature values and a predetermined matrix output signal linked with the predetermined response, and wherein
said processing unit is configured to input, while in said recognition mode, said auditory feature values to the matrix so as to evoke a predetermined matrix output signal that is associatively best match, according to a predetermined criterion applying the weight values, to said input auditory feature values.

The term “processing unit” refers to a functional entity that, at least, partially controls the execution of the required operations needed for carrying out the invention around the associative matrix; it may be implemented as a single unit or a plurality of interconnected processing sub-units comprising e.g. a microprocessor, a microcontroller, a DSP (Digital Signal Processor), a programmable logic chip, a tailored or a dedicated chip (e.g. ASIC), etc. Further, it may in a structural sense be combined with other entities such as the memory, associative matrix and/or the auditory feature extractor, although the functional purposes of the entities still differ from each other.

The term “training mode” refers to a functional mode during which the matrix is configured. Instead of merely capturing a predetermined acoustic signal via a microphone and determining the relating auditory features therefrom for obtaining the associative weight values, the training may also indicate programming proper weight values and associations directly to the matrix without an explicit acoustic signal capturing phase. Especially, the latter may take place by the device manufacturer that pre-programs the agent to recognise a number of commonly used acoustic signals. The user shall advantageously be still entitled to personally train the agent (via acoustic capturing) to recognize further/alternative acoustic signals instead of factory settings.

The term “recognition mode” refers to a functional mode during which the agent is configured to sense environmental acoustic signals and analyse them via the matrix. Correspondingly, the associative matrix may be realized through general or dedicated hardware and/or program code.

The term “user” refers to a person that utilizes the invention and either monitors the portable hearing agent and its alerts directly or indirectly via additional communication taking place between the portable agent and the receiving terminal at the user's disposal. In other words the user is the person to whom the alerts and indications are targeted. Therefore the term “output means” may respectively include both local alerting/informing means but also information transfer means towards remote locations, or selectively only one of those, if remote monitoring is solely exploited and the personal agent is perpetually not in the vicinity of the user. “Alerting” refers to actions performed to get the user's attention. The predetermined response may naturally be just another acoustic signal that the user more likely recognizes instead of the originally sensed one; it may thus indicate different frequency content, higher energy, longer duration than the original signal. Preferably, however, the response signal includes e.g. tactile and/or visual elements. A predetermined text or a picture/symbol may be shown on the display of the agent or a remote receiver, or the agent may vibrate to alert the user after which the recognized sound is shown via visual means on the display. Also the vibration pattern may be used to directly indicate the user the nature of the recognized sound. Thus the alert and the indication may be either separate (˜common alert but specialized indication for each recognized sound) or combined entities (˜also the alerts may differ for the recognized sounds). The overall number of predetermined responses may be lower than the number of predetermined acoustic signals to be recognized, i.e. two or more predetermined acoustic signals activate the same predetermined output signal. In the remote monitoring scenario, the response may just be a message comprising an identifier triggering the alerting/association-specific indication procedure in the receiving terminal.

The term “auditory feature” refers to a feature (signal) the value of which is determined from the electric signal representing the original acoustic signal. The feature value represents the presence of a given feature such as a frequency component or a certain ratio of predetermined frequency components. More examples are listed in the detailed description hereinafter.

Acoustic signals, i.e. sounds, to be later recognized by the portable hearing agent are predetermined prior to the execution of actual continuous monitoring and recognition mode in the agent, which means they are either user-determined e.g. through a training procedure, or factory-determined (in which case the “training” that should be interpreted in a wide sense, e.g. in a form of programming, has been performed by the manufacturer). As to be reviewed later in this text, the training procedure that is applicable for use with the invention is rather simple; therefore letting the users determine the sounds to be recognized by training the agent is the preferable option instead of mere factory-determined settings. Likewise, the predetermined output signals can be either factory-determined or user-determined. Admittedly even factory-determined sounds may work reasonably accurately in situations where they are already widely standardized, considering e.g. refrigerator or freezer beeps, certain doorbell chime, phone ring tone (default), etc. In addition, the factory-determined and the user-determined approached may be combined, i.e. the agent includes factory settings for recognizing the most common (e.g. based on sales statistics) sounds whereas the user may train the device to recognize additional sounds or fully replace the factory sounds with the preferred data relating to the personally more relevant sounds.

In another aspect of the invention a method for distinctively notifying a user of a portable hearing agent about a recognized acoustic signal, the method comprising the steps of:
obtaining a sensed acoustic signal in electric form,
associating, while the agent is in a training mode, the sensed signal with a predetermined response, and activating, while in a recognition mode, the predetermined response,
alerting the user of the agent and indicating the acoustic signal via the predetermined response,
   is characterized in that it further has the steps of:
extracting a plurality of auditory feature values from the sensed signal, wherein said auditory feature values respectively indicate presence or non-presence of predetermined auditory features,
storing in an associative matrix, while in said training mode, weight values representing an association between said auditory feature values and a predetermined matrix output signal linked with the predetermined response, and
inputting, while in said recognition mode, said auditory feature values to the matrix so as to evoke a predetermined matrix output signal that is associatively best match, according to a predetermined criterion applying the weight values, to said input auditory feature values.

As to the utility of the invention, it provides a number of benefits over prior art solutions. The hearing agent can be implemented as software to be used in a more general portable device already comprising the required processing, memory, and IO means, such device thus being e.g. a modern mobile terminal (GSM, UMTS, etc) or a PDA. Alternatively, the invention may be implemented through dedicated, light and small-sized (advantages of a portable apparatus), devices or modules that comprise either specialized hardware realization (microcircuit) or programmed more generic hardware. The associative matrix can be configured rather straightforwardly without exhaustive training procedures that are often quite likely in the case of e.g. traditional neural networks and related training algorithms. Still, the recognition result is far superior to overly simplified sample-by-sample type comparison techniques suggested by the prior art. The matrix solution is computationally efficient, consumes memory space only moderately and enables both fast software and hardware implementations. The matrix approach also supports parallel processing, which facilitates the design of efficient (hardware) implementations. In the default case wherein the characteristic feature values are binary, the acoustic signal representations and the sensed signal may be correspondingly represented as binary arrays. Binary arrays can be processed efficiently and the association be carried out without further pattern recognition processes such as pattern matching, comparison, self-organizing neural networks, back-propagation neural networks and the like, which are often significantly more complex. The associative matrix type solution also enables utilization of incomplete or partly incorrect information in the recognition process.

In a first embodiment of the invention a portable device, e.g. a mobile terminal or a PDA, is equipped with means for carrying out the necessary tasks. The device monitors sounds forwarded by the environment with the help of the associative matrix and informs the user about detected predetermined sounds by vibration and visual clues shown on the device display.

Another embodiment of the invention discloses a remote recognition device such as household robot that is provided with a functional element implementing the features of the portable hearing agent. While the robot moves in the apartment of the user it simultaneously monitors the environment and executes recognition tasks in accordance with the fulcrum of the invention. It also either alerts the user (˜owner/operator) of the robot directly about recognized, predetermined sounds, or forwards the information to a remote receiver carried by the user via preferably wireless information transfer means.

### BRIEF DESCRIPTION OF THE DRAWINGS

Hereinafter the invention is described in more detail by reference to the attached drawings, wherein

FIG. 1 depicts a prior art hearing aid.

FIG. 2 is a block diagram of a portable hearing agent device according to the invention.

FIG. 3 illustrates the associative process of the invention in more detail.

FIG. 4 visualizes the first embodiment of the invention.

FIG. 5 visualizes the second embodiment of the invention.

FIG. 6 is a flow chart of the method of the invention.

### DETAILED DESCRIPTION OF THE EMBODIMENTS OF THE INVENTION

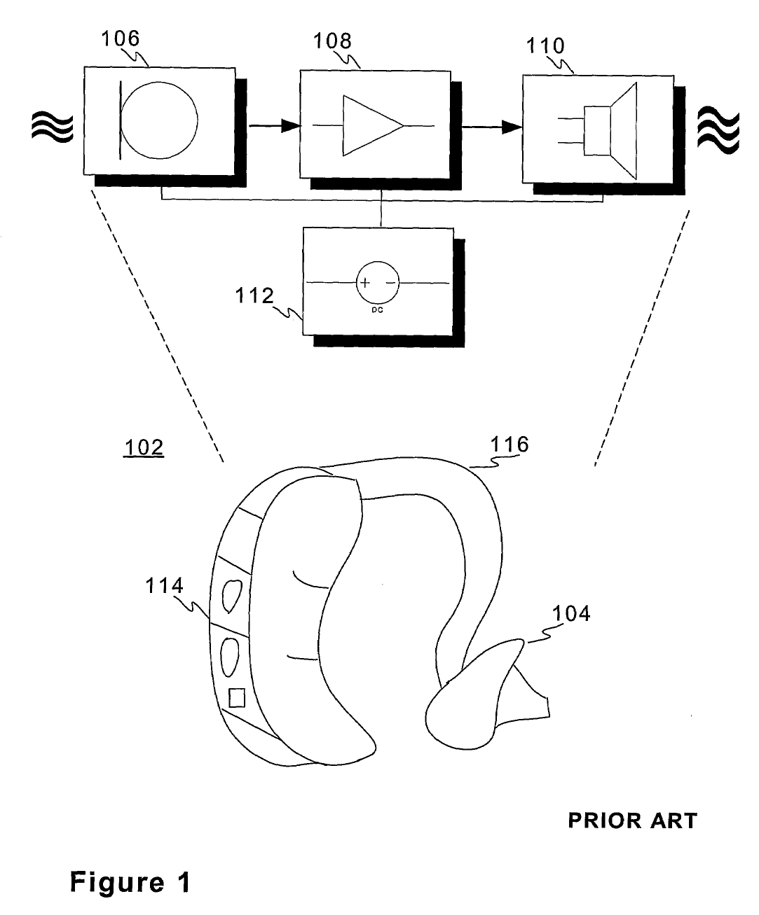

FIG. 1 was already described above in conjunction with the description of relevant prior art.

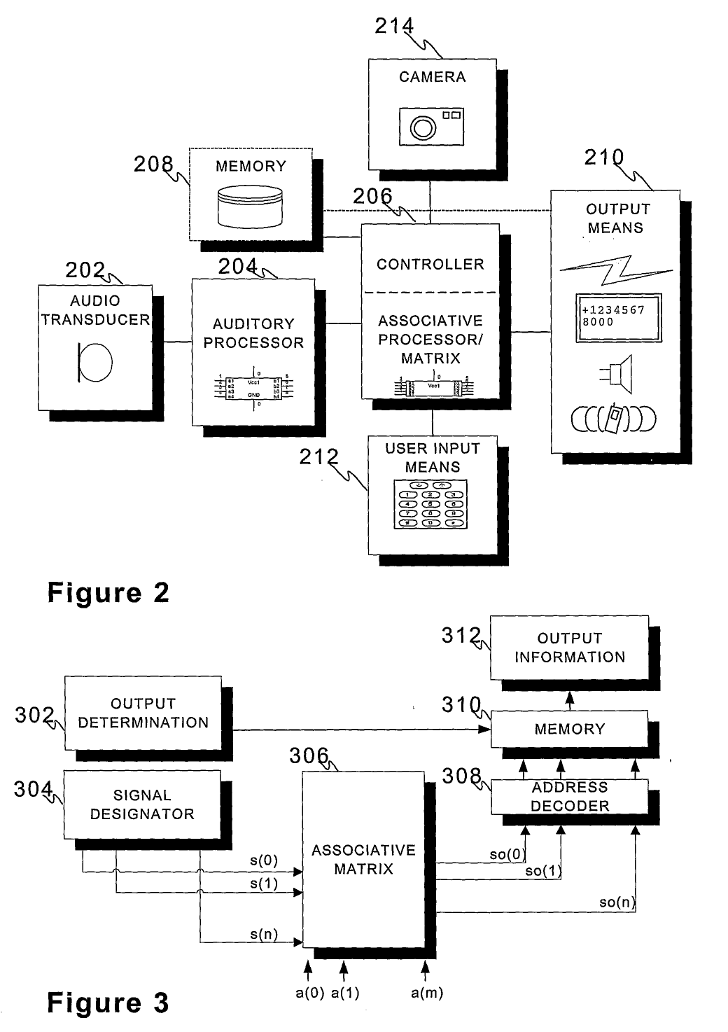

FIG. 2 represents a block diagram of the portable hearing agent. The skilled readers will realize that the diagram shown is only an exemplary one and also other possibilities for carrying out the inventive concept exist. The agent can be implemented as an independent device, a specialized software and/or hardware feature of a multipurpose host device, or a module to be attached to a host device. The agent may solely utilize the existing hardware of the host device or, if provided in a module, also the hardware of its own.

The hearing agent comprises at least one acoustic sensor 202, e.g. a microphone, an auditory processing entity 204 that transforms the received audio signals into auditory feature signal arrays, and a processor 206 that executes an associative process, which associates sounds with desired information and evokes this information when the corresponding sound is received. The processors 204, 206 and a memory 208 (possibly integrated in the processor(s), therefore dotted as optional) required for executing and storing instructions and data can be put into practise as a single integrated chip, a number of separate chips, through programmable logic, etc. The entities have been physically separated in the figure for clarity reasons and to visualize the various functional aspects of the device.

User input means 212 such as a keypad or a keyboard, various buttons, voice control, touch screen, a controller, etc provides the user of the device with control means for determining the configuration of the inventive arrangement and associative matrix therein, for example.

Output means 210 may include one or more elements such as a display, a loudspeaker, a vibration unit (optionally integrated in a battery of the device), or information transfer means (preferably wireless) like a transceiver for alerting the user and indicating him the associated (associatively best match) acoustic signal via the linked output signal. A single element may be used just for alerting the user (˜catching his attention) or indicating the particular output signal, or for both purposes. E.g. a certain vibration pattern (rhythm and intensity of vibration) may do the both tasks whereas a mere textual message or an image on the display may not be enough in all occasions to catch the user's attention, whereby the data on the display is possibly not even noticed by the user, not at least in the short run.

One optional functional element of the agent is a still or a video camera 214 that is especially useful in the second embodiment of the invention, wherein the recognized sound may direct the robot to take an image or a video of the sound source and provide the user with it either locally or via information transfer means. The sound source localization including at least direction estimation can be carried out through a microphone array comprising a plurality of microphones, for example, or other prior art localization arrangements.

From a high-level functional standpoint, the hearing agent listens to the environment by the sensor 202. The auditory processor 204 processes the sound information into a large array of auditory feature values that are preferably represented by binary signals. The processor 206 executes an associative process: during an initial training operation (first mode) it associates auditory feature signal arrays with desired information so that afterwards (second mode) these feature signal arrays, when detected, will evoke the associated information, which can be then output and represented at the other output devices 210. During the training operation a sound to be detected is presented to the device simultaneously with the desired information; for instance the sound of doorbell is accompanied by the text “doorbell”, which is entered via the keyboard, for example. Thereafter the sound of the doorbell will cause the text “doorbell” to be displayed. In another example, visual information, which is captured by the camera 214 or otherwise provided to the agent, is associated with the detected sound. For instance the sound of the doorbell can be associated with the image of the door. When the sound of the doorbell is detected then the image of the door is presented. Text, vibration and other information can be presented together with the images as a predetermined response.

Considering the transformation of a sound pattern into an array of auditory feature signals, each of these signals represents the presence of a given feature such as an audio frequency component or a certain value for the ratio of certain frequency components. The sounds of interest in this invention are either continuous or transient. Certain continuous sounds, such as the indicator sounds of refrigerators typically have a simple spectrum with strong fundamental frequency. In these cases the feature signals could be arranged to indicate the presence of the fundamental frequency and some harmonics. In other cases the spectrum of the sound is more continuous, whereupon it is advantageous to inspect the relative power content of bands of frequencies. Moreover, different sound coefficients (e.g. linear prediction) may be derived from the input sound and certain value ranges thereof used for feature study. Various auditory features can be generally figured out via previously known methods such as filter banks, Fourier, Cosine or Walsh-Hadamard transforms and other suitable transforms.

In the exemplary case to be reviewed herein, the auditory feature signals are substantially binary (i.e. representing two distinct values) signals, i.e. they include a binary-form characteristic feature value that will tell whether a certain predetermined auditory feature is present or not in the analysed signal. E.g. a logical one would indicate the presence of the represented feature and a logical zero would indicate that the feature is not present. Respectively also other input or output signals of the associative matrix are binary. A more versatile feature signal (e.g. an energy value or a coefficient) can be converted into a binary form with a number of comparators that detect a specific feature value or value range and output logical one when the specific value is detected and zero at other times according to the formula:

f(i)=1 when Vl<U<Vh, else f(i)=0 (1)

In the formula f(i) is the specific feature signal, U is the detected continuous value, Vl is the lower limit of the specific value and Vh is the upper limit of the specific value.

Next, the associative process that is executed by the processor 206 in the FIG. 2 is described in more detail with reference to FIG. 3. This process involves the operations of the associative matrix.

The associative matrix can be implemented through dedicated hardware including one or more tailored hardware chips; notice block 206 of FIG. 2. Likewise, a controller for managing the matrix, see FIG. 3 and related discussion, and executing other actions in the agent can be implemented either as a part of the matrix circuit(s), and/or as an additional controller/processor entity or a plurality of controller entities possibly utilizing also a separate memory 208 for storing information. In case the associative matrix is realised as a program code, a multipurpose processor 206, in addition to other tasks, may access the memory entity 208, i.e. a memory structure comprising a plurality of matrix cells that store the associative weight values, i.e. the characteristic feature values of the predetermined sounds to be later recognized for evoking the associated output. The processor 206 thus accesses the matrix, in the first operation mode (training), to input the characteristic auditory feature values of the predetermined acoustic signals to create the respective weight value collections, and, in the second operation mode (recognition), to determine output signal to the current associative input to the matrix that is derived from the auditory features of the sensed signal. Theory behind an associative matrix in general is more profoundly described in publication [1].

In FIG. 3, signals s(i) represent input signals from the signal designator 304. Moreover, signals so(i) are the output signals of the matrix and signals a(j) are the associative input signals (auditory feature values) for the matrix. The matrix associates, during the first mode, an input signal s(i) with a group of associative input signals a(j) so that, at a later time instant during the second mode, the input signal is evoked by the associated input signal a(j) group when determined from the currently sensed signal. The evoked input signal will emerge as the corresponding output signal so(i) so basically the meanings of the signals s(i) and so(i) are the same, that is, they depict the same entity.

Reverting now to the aforesaid doorbell example, for instance the text “doorbell” may solely constitute the preferred output information 302 that is then stored in an addressable memory location of the memory 310 and assigned with one of the signals s(i). If the piece of information is the first piece to be learned by the device then the signal designator 304 sets s(i)=s(0) and the setting s(0)=1 would mean that the text “doorbell” shall be indicated by a matrix output signal. If the piece of information is the second piece to be learned by the device then the signal designator 304 sets s(i)=s(1) and so on. In this way only one signal can be cleverly set to represent a large chunk of information. During the training operation so(i)=s(i) and especially in this example so(0)=s(0)=1. The memory address decoder 308 thus transforms the so-vector (1,0,0, . . . , 0) into a corresponding memory address wherefrom the output information (e.g. image, text, sound, vibration) to be exploited (in this example the text “doorbell”) can be found, i.e. the link between a certain matrix output and a certain predetermined response is solved. The memory 310 must naturally retain its information also when the device is powered down. This can be achieved by using non-volatile memories such as flash-memories or a specific battery back-up.

As the associative matrix 306 associates, during the first mode, the signal s(0) with the group of the auditory feature signals a(i) via a number of weight values, during the second mode the doorbell auditory feature signal group or a group at least relatively close to that (see the “best match” test) input to the matrix 306 will evoke the signal so(0)=1. This particular output is transformed by the memory address decoder 308 into the corresponding memory address, and the information to be displayed (the text “doorbell”) is thus retrieved from the memory and forwarded to the display device 312 for visualization.

The operation of one possible implementation of the associative matrix can be described with mathematical rigor as follows:

During the first mode (“training”), an associative link between input signal array s(i) and associative input signal array a(j) is created by presenting two arrays simultaneously to the matrix and creating the association weight values. The weight value is determined as

w(i,j)=s(i)*a(j) (2)

where
s(i)=the input of the associative matrix (zero or one), and
a(j)=the associative input of the associative matrix (zero or one).

Initially all the weight values have a zero value. Inputs a(j) represent the auditory feature values derived from the predetermined acoustic signal to be later recognized during the second mode.

During the second mode (“recognition”), the associated signal so(i) corresponding to signal s(i) is evoked by the signal array a(j) according to the formula 3 below

Σ(i)=Σw(i,j)*a(j) (3)

where
Σ(i)=evocation sum
w(i,j)=association weight value (zero or one).

This equation is easier to analyze in more detail as a matrix-vector multiplication procedure:

Σ(1)=w(1,1)*a(1)+w(1,2)*a(2)+w(1,3)*a(3)+ . . . +w(1,m)*a(m)

Σ(2)=w(2,1)*a(1)+w(2,2)*a(2)+w(2,3)*a(3)+ . . . +w(2,m)*a(m)

Σ(3)=w(3,1)*a(1)+w(3,2)*a(2)+w(3,3)*a(3)+ . . . +w(3,m)*a(m)

. . .

Σ(n)=w(n,1)*a(1)+w(n,2)*a(2)+w(n,3)*a(3)+ . . . +w(n,m)*a(m).

The evocation sums tell which signal s(i) is most strongly associated with the array a(j). The final output array so(i) of the matrix (matrix output signal) is now determined on the basis of an associative (best-)match estimate:

so(i)=0 IF Σ(i)<threshold,

so(i)=1 IF Σ(i)≧threshold (4)

where

threshold=max{Σ(i)}.

From the above mathematical formulations in view of FIG. 3 it is straightforward to realize that even a dedicated hardware implementation of the matrix is rather alluring as the utilized input/output signals are in many ways optimum binary form and exploitation of parallel processing is possible.

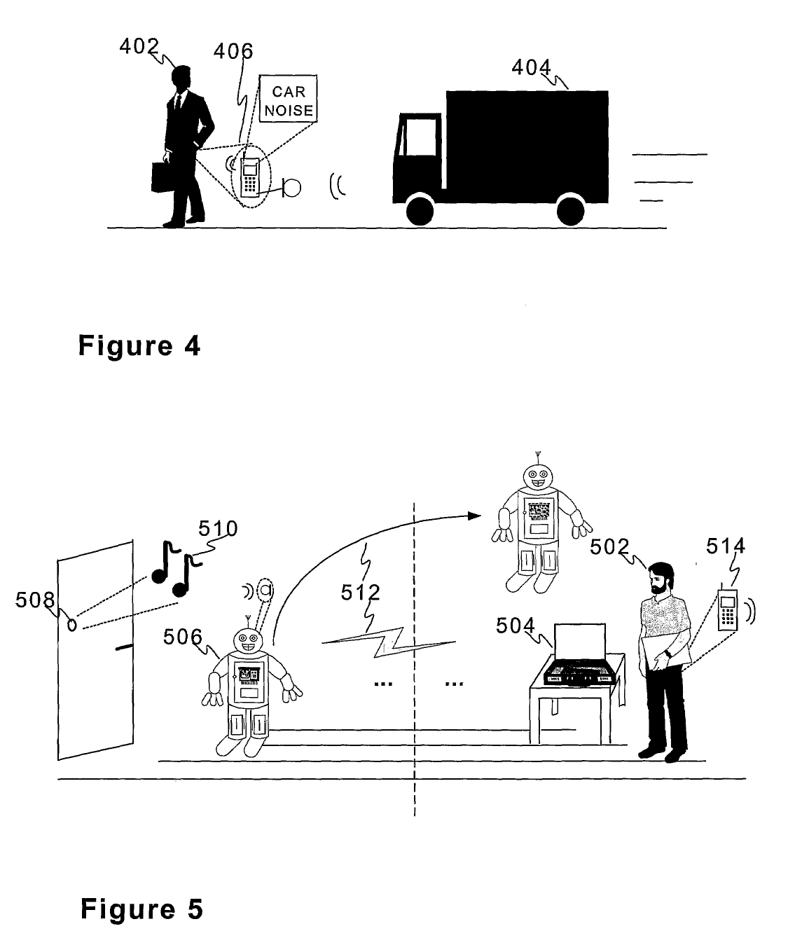

FIG. 4 depicts the scenario of the first embodiment of the invention. A person 402 with impaired hearing is crossing a street on his own thoughts and does not hear the sound of an incoming lorry 404. Fortunately he is a carrying a portable device 406 such as a mobile terminal or a PDA with him, the device 406 being equipped with the hearing agent arrangement of the invention. Due to an activated monitoring process the device 406 receives environmental sounds, funnels them into the associative matrix and recognizes the sound of the approaching lorry as traffic noise. The person 402 may have trained the device 406 by himself due to being aware of his occasional inattention outdoors together with the hearing defect causing sometimes dangerous situations. Alternatively, the device 406 may have been factory-programmed to recognize car noise, for example. The device 406 alerts the user by the combination of vibration, an exceptionally loud ring tone, and a message “CAR NOISE” shown on the display. The vibration and the ring tone may be tailored according to the recognized sound and thus act both as an alert and a more specific indication of the sound source, whereas the mere message hardly catches anyone's attention alone, if e.g. the portable device 406 is kept away from the person's direct eye contact.

Even if the recognition did not work perfectly in a sense that a “wrong” response (originally associated with another sound) was activated, which might happen due to background noise or other variations in environmental conditions resulting distortion in the sensed auditory features in relation to the features of the acoustic signal actually emitted by the primary sound source, the match is still functionally the best match on the basis of the created associations, and, the person 402 is anyhow alerted for an event he/she should potentially take notice on.

The device 406 can be implemented along the guidelines given in the FIGS. 2 and 3 and the relating text. A corresponding use scenario may alternatively take place in a more stable environment, e.g. at home of the person 402, where the person 402 may train the device 406 to recognize various discrete sounds emitted by e.g. a phone, a doorbell, an oven, an alarm clock, a refrigerator, a letterbox lid swing, a dog bark, and boiling water.

FIG. 5 depicts the second embodiment of the invention, wherein a person 502 packing his briefcase 504 somewhat intensively luckily carries a wireless receiver 514, e.g. a dedicated device or a mobile terminal/PDA with suitable software, with him. The portable hearing agent is in this embodiment a remote device integrated as software or as an attachable SW/HW module in a household/entertainment robot 506. In the visualized scenario the robot 506 is capable of moving and observing the environment through a number of cameras and microphones. The robot 506 analyses the sensed sounds by the associative matrix and recognises the jingle 510 caused by the doorbell 508 as one of the predetermined acoustic signals. The robot 506 takes a photo of the door as a result of sound source localization and/or stores the sound for playback (household and entertainment robots are equipped with loudspeakers by default, or the display/loudspeaker can be introduced thereto in the hearing agent module) after which it either transmits a triggering signal 512 to the receiver 514, if provided with suitable transmission means like a wireless transceiver, or seeks one's way to the person 502 and displays the sensed image optionally reproducing the recognized sound via the loudspeaker. Again, FIGS. 2 and 3 and related discussion may be used as a precept for implementing also this embodiment. In case the robot does not bear the faculty of sufficient locomotion, it actually works as a fixed-location remote hearing agent that recognizes the predetermined sounds and transfers the predetermined triggering signals forward to a receiver in the vicinity of the user who is then alerted.

Further, the embodiments may be combined in a creative manner, i.e. taking suitable options from both ones to construct a tailored system. For example, the hearing agent of the first embodiment can be provided, either in addition to or instead of a microphone, with a receiver (preferably wireless) that receives electric signal from a remote unit monitoring the neighborhood around its location. The remote unit comprises a microphone of its own but not fully capable recognition logic. Thus it sends the sensed audio signal forward to the hearing agent that analyses the incoming (electric form) signal and performs the execution, recognition, and alerting processes as described hereinbefore.

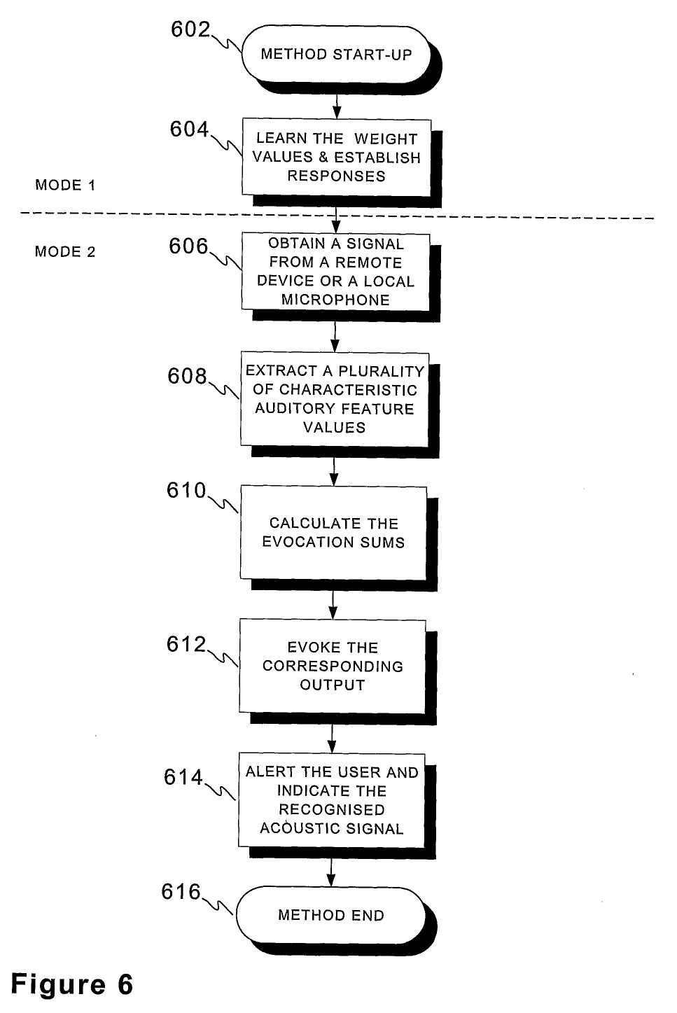

A flow chart disclosing one option for carrying out the method of the invention is disclosed in FIG. 6. In step 602 the method execution is started in the hearing agent, and the necessary application(s) are launched, hardware components initialised, etc. The dotted line represents the boundary between mode 1 (training mode) and mode 2 (recognition mode) steps. First mode, see step 604, refers to the association process, i.e. the determination of weight values forming the cells of the associative matrix as explained in conjunction with the description of FIG. 3. Step 604 explicitly refers to storing the weight value collections derived from the auditory feature values of predetermined acoustic signals to be recognized by the agent. Implicitly such storing naturally requires prior acquisition of such values, i.e. by reception or by locally determining the auditory feature values (presence/non-presence of the auditory features) from the acoustic signals sensed via the sensor.

In the second mode the agent analyses the received sounds so as to trigger the pre-determined responses whenever a corresponding sound is recognized. Namely, in step 606 a sensed audio signal is obtained in electric form either through a local microphone or a remote device comprising a microphone and a transmitter. Step 608, which may take place during both the training and the recognition modes, denotes the extraction of auditory feature values from the sensed signal, wherein the auditory feature values indicate presence or non-presence of the predetermined auditory features, e.g. certain frequency component or a certain value (range) for the ratio of predetermined frequency components (in order to mitigate the effect of absolute sound levels that easily fluctuate due to a plurality of reasons). In step 610 the aforementioned evocation sums are calculated and in step 612 the matrix output is determined based on the associative best-match in order to provide the further entities (e.g. address decoder 308) with sufficient information for distinctively alerting 614 the user of the agent. “Distinctiveness”, as being clear to a skilled reader, will in connection with the current invention mean separability of the recognized sound indications as perceived by the user. This can be achieved by the use of recognized sound-specific vibration patterns, sounds, texts, images, video, etc. The method execution is ended in step 616. In real-life scenario the method steps may be executed in a continuous manner and even in parallel, depending on the implementation, as the sound signal may be obtained 606 and buffered continuously while the subsequent steps 608->are performed to the previously obtained signal e.g. in cases where the sound is processed on (fixed length) frame-by-frame basis or by separating consecutive sounds from each other and from the background noise by detecting the pauses/silence between them.

Software for implementing the method of the invention may be provided on a carrier medium like a floppy disk, a CD-ROM, and a memory card, for example.

Optional data transmission between a hearing agent and another device (either the remote microphone device or the receiving terminal of the user depending on the embodiment) may take place over previously known wireless technologies and standards such as GSM, UMTS, Bluetooth, infrared protocols, and WLAN.

It should be obvious to a one skilled in the art that different modifications can be made to the present invention disclosed herein without diverging from the scope of the invention as defined by the following claims. For example, utilized devices and methods steps or mutual order thereof may vary still converging to the basic idea of the invention. As one particular note, the invention may also be utilized by persons not having a hearing defect; the invention just intensifies and diversifies the normal hearing experience in those cases. For example, people having a bad concentration or people who are involved in a plurality of simultaneous tasks may benefit from the increased attention the hearing agent is able to provide them with.

### REFERENCES

[1] Haikonen Peniti O. A. (1999). An artificial Cognitive Neural System Based on a Novel Neuron Structure and a Reentrant Modular Architecture with Implications to Machine Consciousness. Dissertation for the degree of Doctor of Technology, Helsinki University of Technology, Applied Electronics Laboratory, Series B: Research Reports B4

1. A portable hearing agent comprising
an audio sensor for transforming an acoustic signal into a representative electric signal,
a processing unit configured, while in a training mode, to associate the sensed signal with a predetermined response, and, while in a recognition mode, to activate the predetermined response,
an output module for alerting a user of the agent and indicating the acoustic signal via the predetermined response,
an auditory feature extractor for determining auditory feature values of the sensed signal, said auditory feature values indicating presence or non-presence of predetermined auditory features, and
an associative matrix configured to store, while in said training mode, weight values representing an association between said auditory feature values and a predetermined matrix output signal linked with the predetermined response, and
wherein said processing unit is configured to input, while in said recognition mode, said auditory feature values to the matrix so as to evoke a predetermined matrix output signal that is an associatively best match, according to a predetermined criterion applying the weight values, to said input auditory feature values.

2. The hearing agent of claim 1, further comprising a camera for taking a video sequence or a still image of a localized sound source emitting the sensed signal.

3. The hearing agent of claim 1, wherein said output module includes at least one element selected from the group consisting of: a display, a loudspeaker, a vibration unit, and an information transfer module.

4. The hearing agent of claim 1, wherein said predetermined response includes at least one element selected from the group consisting of: a sound, an image, a video sequence, a text, and a vibration pattern.

5. The hearing agent of claim 1, wherein said auditory features include at least one element selected from the group consisting of: a frequency component, a ratio of predetermined frequency components, signal energy, and a sound coefficient value.

6. The hearing agent of claim 1, configured to sense, during said training mode, a user-determined acoustic signal as one of said predetermined acoustic signals, to determine the auditory feature values therefrom and to store the corresponding associative weight values in the associative matrix.

7. The hearing agent of claim 1, wherein said predetermined response is user-determined.

8. The hearing agent of claim 1, wherein said auditory feature values are binary.

9. The hearing agent of claim 1, wherein the auditory feature values relating to a predetermined acoustic signal are respectively stored as cell values of an associative matrix, preferably on a single row or column.

10. The hearing agent of claim 1, configured to multiply a number of weight values relating to a certain matrix output with auditory feature values of the sensed signal and summing the multiplication results together to form an aggregate value.

11. The hearing agent of claim 10, wherein an output with the highest aggregate value is selected as the associatively best mach.

12. The hearing agent of claim 1, further comprising a linker for linking the predetermined matrix output signal with the predetermined response.

13. The hearing agent of claim 1, comprising a plurality of audio sensors for localizing a sound source.

14. The hearing agent of claim 1 that is a mobile terminal, a Personal Digital Assistant, a module attachable to another device, or a robot.

15. A method comprising:
obtaining a sensed acoustic signal in electric form,
associating, while the agent is in a training mode, the sensed signal with a predetermined response, and activating, while in a recognition mode, the predetermined response,
alerting the user of the agent and indicating the acoustic signal via the predetermined response,
extracting a plurality of auditory feature values from the sensed signal, wherein said auditory feature values respectively indicate presence or non-presence of predetermined auditory features,
storing in an associative matrix, while in said training mode, weight values representing an association between said auditory feature values and a predetermined matrix output signal linked with the predetermined response, and
inputting, while in said recognition mode, said auditory feature values to the matrix so as to evoke a predetermined matrix output signal that is an associatively best match, according to a predetermined criterion applying the weight values, to said input auditory feature values.

16. (canceled)

17. (canceled)

18. A readable memory stored with instructions for execution by a processor, for:
obtaining a sensed acoustic signal in electric form,
associating, while the agent is in a training mode, the sensed signal with a predetermined response, and activating, while in a recognition mode, the predetermined response,
alerting the user of the agent and indicating the acoustic signal via the predetermined response,
extracting a plurality of auditory feature values from the sensed signal, wherein said auditory feature values respectively indicate presence or non-presence of predetermined auditory features,
storing in an associative matrix, while in said training mode, weight values representing an association between said auditory feature values and a predetermined matrix output signal linked with the predetermined response, and
inputting, while in said recognition mode, said auditory feature values to the matrix so as to evoke a predetermined matrix output signal that is an associatively best match, according to a predetermined criterion applying the weight values, to said input auditory feature values.

19. A portable hearing agent comprising:
means for transforming an acoustic signal into a representative electric signal,
means for associating the sensed signal with a predetermined response while in a training mode, and while in a recognition mode, for activating the predetermined response,
means for alerting a user of the agent and indicating the acoustic signal via the predetermined response,
means for determining auditory feature values of the sensed signal, said auditory feature values indicating presence or non-presence of predetermined auditory features, and
means for storing weight values representing an association between said auditory feature values and a predetermined matrix output signal linked with the predetermined response while in said training mode, and
wherein said means for associating is for inputting, while in said recognition mode, said auditory feature values to the means for storing so as to evoke a predetermined matrix output signal that is an associatively best match, according to a predetermined criterion applying the weight values, to said input auditory feature values.
